(19) United States
(12) Patent Application Publication
(10) Pub. No.: US 2020/0023320 A1
(43) Pub. Date: Jan. 23, 2020

(54) SEPARATION COMPOSITE MEMBRANE, SEPARATION MEMBRANE MODULE, SEPARATOR, COMPOSITION FOR FORMING SEPARATION MEMBRANE, AND METHOD OF PRODUCING SEPARATION COMPOSITE MEMBRANE

(71) Applicant: FUJIFILM Corporation, Tokyo (JP)

(72) Inventor: Yusuke IIZUKA, Kanagawa (JP)

(73) Assignee: FUJIFILM Corporation, Tokyo (JP)

(21) Appl. No.: 16/550,297

(22) Filed: Aug. 26, 2019

Related U.S. Application Data
(63) Continuation of application No. PCT/JP2018/007052, filed on Feb. 26, 2018.

(30) Foreign Application Priority Data
Feb. 28, 2017 (JP) 2017-037646

(51) Int. Cl. B01D 69/12; B01D 71/12; B01D 71/42; B01D 69/10; B01D 53/22; C08J 7/04

(52) U.S. Cl. CPC B01D 69/122; B01D 71/12; B01D 71/42; C08J 2433/16; B01D 53/22; C08J 7/047; C08J 2377/06; B01D 69/10

(57) ABSTRACT

A separation composite membrane, including a porous support layer, and a separation layer provided on the porous support layer and contains the following polymer a1 and b1; a separation membrane module; a separator; and a composition for forming a membrane suitable for preparing the separation composite membrane.

Polymer a1: A polymer whose ratio of a permeation rate of carbon dioxide to a permeation rate of methane is 15 or greater, and the permeation rate of the carbon dioxide is smaller than that in the polymer b1 and which has a solubility parameter of 21 or greater

Polymer b1: A polymer whose permeation rate of carbon dioxide is 200 GPU or greater, and a ratio of the permeation rate of the carbon dioxide to methane is smaller than that in the polymer a1 and which has a solubility parameter of 16.5 or less

### CROSS-REFERENCE TO RELATED APPLICATIONS

This application is a Continuation of PCT International Application No. PCT/JP2018/007052 filed on Feb. 26, 2018, which claims priority under 35 U.S.C. § 119 (a) to Japanese Patent Application No. 2017-037646 filed in Japan on Feb. 28, 2017. Each of the above applications is hereby expressly incorporated by reference, in its entirety, into the present application.

### BACKGROUND OF THE INVENTION

### 1. Field of the Invention

The present invention relates to a separation composite membrane, a separation membrane module, a separator, a composition for forming a separation membrane, and a method of producing a separation composite membrane.

### 2. Description of the Related Art

A material formed of a polymer compound exhibits permeability specific to a fluid for each material. Based on this property, it is possible to cause selective permeation and separation out of a desired fluid component using a separation membrane formed of a specific polymer compound. The application fields of this membrane separation technique are diverse. For example, separation and recovery of carbon dioxide from large-scale carbon dioxide generation sources such as thermal power plants, cement plants, or ironworks blast furnaces have been performed using this separation membrane, and removal of impurity gas from natural gas or biogas has been performed using a separation membrane.

In order to efficiently separate a target component from fluid components using a membrane separation technique, a separation membrane is required to have a sufficient permeability and mechanical strength for withstanding high pressure conditions as well as excellent separation selectivity. As a membrane form for realizing these properties, a form of a composite membrane obtained by making a separation layer thin on a porous membrane having the mechanical strength, using a material having the separation function and a material having the mechanical strength as separate materials, has been known. By employing the form of a composite membrane, it is possible to realize sufficient permeability while achieving desired mechanical strength.

Further, a membrane material that realizes both of excellent separation selectivity and permeability has been examined. For example, JP1990-502084A (JP-H02-502084A) describes a membrane that is formed using a mixture of poly(methyl methacrylate) which has a degraded permeability even through the separation selectivity is excellent and a cellulose derivative having an excellent permeability. According to the technique of JP1990-502084A (JP-H02-502084A), it is considered that a poly(methyl methacrylate) membrane can be formed into a thin layer without causing defects so that a uniform continuous thin film exhibiting desired separation selectivity and permeability is obtained.

### SUMMARY OF THE INVENTION

As described above, the membrane form and the membrane material for improving the separation performance have been examined, and many reports have been made. However, a separation membrane which achieves both of separation selectivity and permeability at desired sufficiently high levels has not been realized yet. Accordingly, there has been a demand for separation membranes of the related art to have a further improved separation efficiency.

An object of the present invention is to provide a separation composite membrane which is capable of achieving both of separation selectivity and permeability at higher levels even at the time of use under a high pressure condition. Further, another object of the present invention is to provide a separation membrane module and a separator, formed of the separation composite membrane. Further, a still another object of the present invention is to provide a composition for forming a separation membrane suitable for preparing the separation composite membrane and a method of producing the separation composite membrane formed of this composition.

The above-described problems of the present invention are solved by the following means.

[1] A separation composite membrane comprising: a porous support layer; and a separation layer which is provided on the porous support layer and contains the following polymer a1 and the following polymer b1.

polymer a1: a polymer in which a ratio of a permeation rate of carbon dioxide to a permeation rate of methane is 15 or greater and the permeation rate of the carbon dioxide is smaller than that in the polymer b1 and which has a solubility parameter of 21 or greater polymer b1: a polymer in which a permeation rate of carbon dioxide is 200 GPU or greater and a ratio of the permeation rate of the carbon dioxide to a permeation rate of methane is smaller than that in the polymer a1 and which has a solubility parameter of 16.5 or less

[2] The separation composite membrane according to [1], in which the separation composite membrane includes the porous support layer, a layer a2 containing the polymer a1, and a layer b2 containing the polymer b1 in this order.

[3] The separation composite membrane according to [1] or [2], in which the separation layer is formed using a coating solution obtained by dissolving the polymer a1 and the polymer b1 in a solvent.

[4] The separation composite membrane according to any one of [1] to [3], in which a content of the polymer a1 is smaller than a content of the polymer b1 in the separation layer.

[5] The separation composite membrane according to any one of [1] to [4], in which a proportion of the content of the polymer a1 in a total content of the polymer a1 and the polymer b1 in the separation layer is 40% by mass or less.

[6] The separation composite membrane according to [5], in which the proportion is 20% by mass or less.

[7] The separation composite membrane according to any one of [1] to [6], in which the solubility parameter of the polymer a1 is 23.5 or greater.

[8] The separation composite membrane according to any one of [1] to [7], in which the solubility parameter of the polymer a1 is 30 or less.

[9] The separation composite membrane according to any one of [1] to [8], in which the solubility parameter of the polymer b1 is 15.5 or less.

[10] The separation composite membrane according to any one of [1] to [9], in which the solubility parameter of the polymer b1 is 15 or less.

[11] The separation composite membrane according to any one of [1] to [10], in which the solubility parameter of the polymer b1 is 14 or greater.

[12] The separation composite membrane according to any one of [1] to [11], in which the polymer a1 is a cellulose compound.

[13] The separation composite membrane according to any one of [1] to [12], in which the ratio of the permeation rate of carbon dioxide to the permeation rate of methane in the polymer a1 is 20 or greater.

[14] The separation composite membrane according to any one of [1] to [13], in which the permeation rate of carbon dioxide in the polymer b1 is 350 GPU or greater.

[15] The separation composite membrane according to any one of [1] to [14], which is used for gas separation.

[16] The separation composite membrane according to [15], in which a gas as a target for the gas separation is a mixed gas containing carbon dioxide and methane.

[17] A separation membrane module comprising: the separation composite membrane according to any one of [1] to [16].

[18] A separator comprising: the separation composite membrane according to any one of [1] to [16].

[19] A composition for forming a separation membrane, comprising: the following polymer a1; the following polymer b1; and a solvent.

polymer a1: a polymer in which a ratio of a permeation rate of carbon dioxide to a permeation rate of methane is 15 or greater and the permeation rate of the carbon dioxide is smaller than that in the polymer b1 and which has a solubility parameter of 21 or greater

polymer b1: a polymer in which a permeation rate of carbon dioxide is 200 GPU or greater and a ratio of the permeation rate of the carbon dioxide to a permeation rate of methane is smaller than that in the polymer a1 and which has a solubility parameter of 16.5 or less

[20] A method of producing a separation composite membrane, comprising: coating a porous support layer with the composition for forming a separation membrane according to [19] to form a coated film; and drying the coated film.

The numerical ranges shown using “to” in the present specification indicate ranges including the numerical values described before and after “to” as the lower limits and the upper limits.

The separation composite membrane, the separation membrane module formed of the separation composite membrane, and the separator formed of the separation composite membrane according to the embodiment of the present invention enable formation of a polymer layer contributing to separation selectivity on an ultrathin membrane without causing defects, in the separation layer of the separation composite membrane, achievement of both of excellent permeability and excellent separation selectivity at high levels even at the time of use under a high pressure condition, and separation of a specific component in a fluid at a high speed with high selectivity.

Further, the composition for forming a separation membrane and the method of producing the separation composite membrane according to the embodiment of the present invention can be suitably used for producing the separation composite membrane according to the embodiment of the present invention.

### BRIEF DESCRIPTION OF THE DRAWINGS

FIG. 1 is a cross-sectional view schematically illustrating an embodiment of a separation composite membrane of the present invention.

### DESCRIPTION OF THE PREFERRED EMBODIMENTS

A preferred embodiment of a separation composite membrane (hereinafter, also simply referred to as a “composite membrane according to the embodiment of the present invention”) according to the embodiment of the present invention will be described.

[Separation Composite Membrane]

The composite membrane according to the embodiment of the present invention is in the form in which a separation layer is provided on a porous support layer, and this separation layer contains two kinds of specific polymers having different characteristics. A preferred embodiment of the composite membrane of the present invention will be described with reference to the accompanying drawing, but the composite membrane according to the embodiment of the present invention is not limited to the form illustrated in the FIGURE except for the matter defined in the present invention.

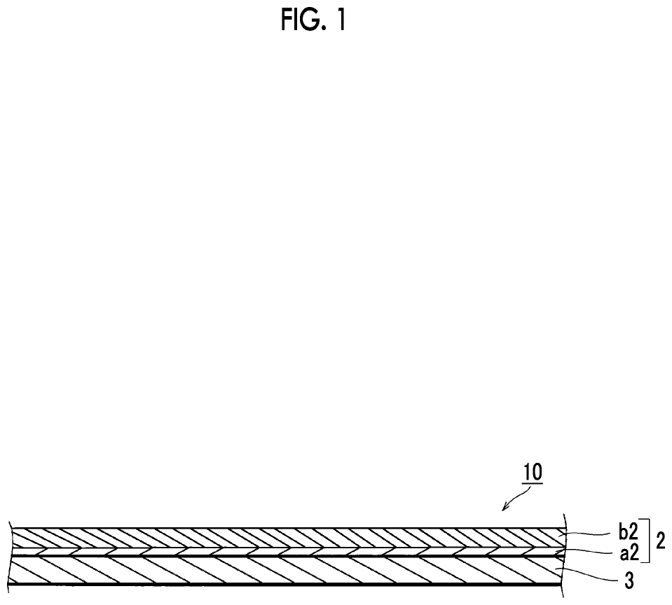

FIG. 1 is a cross-sectional view schematically illustrating a preferred form of the composite membrane according to the embodiment of the present invention. A composite membrane 10 illustrated in FIG. 1 is formed such that a separation layer 2 is provided on a porous support layer 3. The separation layer 2 in the form illustrated in FIG. 1 has a laminated structure of a layer a2 which has an excellent separation selectivity and contains a polymer a1 described below and a layer b2 which has an excellent permeability and contains a polymer b1 described below and is in contact with the porous support layer 3 on a side of the layer a2.

The composite membrane according to the embodiment of the present invention may further have a support (not illustrated), such as non-woven fabric described below, on a lower side of the porous support layer 3 (on a side opposite to a side where the separation layer 2 is provided). Further, the composite membrane according to the embodiment of the present invention may have another layer (not illustrated), such as a siloxane compound layer described below, between the porous support layer 3 and the separation layer 2.

In the composite membrane illustrated in FIG. 1, a fluid to be separated is supplied from an upper side of the separation membrane (a side of the layer b2), and a specific fluid component in this fluid is selectively discharged from a lower side.

In the present specification, in regard to the expressions related to up and down, a side where a fluid to be separated is supplied is set as “up” and a side where the component in the fluid permeates through the membrane and is discharged is set as “down” unless otherwise specified.

The forms of each layer constituting the composite membrane according to the embodiment of the present invention will be described in order.

<Porous Support Layer>

The porous support layer included in the composite membrane according to the embodiment of the present invention is not particularly limited as long as the layer has a desired mechanical strength and has a permeability with respect to a fluid, and it is preferable that the porous support layer is formed of a porous membrane of an organic polymer. The thickness of the porous support layer is preferably in a range of 1 to 3000 μm, more preferably in a range of 5 to 500 μm, and still more preferably in a range of 5 to 150 μm. The pore structure of this porous support layer has an average pore diameter of typically 10 μm or less, preferably 0.5 μm or less, and more preferably 0.2 μm or less. The porosity of the porous support layer is preferably in a range of 20% to 90% and more preferably in a range of 30% to 80%.

Here, as the porous support layer, a layer in which the permeation rate of carbon dioxide is 2×10⁻⁴ cm³ (STP)/cm²·sec·cmHg (1000 GPU) or greater in a case where carbon dioxide is supplied to the porous support layer (a membrane formed of only the porous support layer) by setting the temperature to 40° C. and the total pressure on the gas supply side to 5 MPa can be employed. Further, a layer in which the permeation rate of carbon dioxide is 1500 GPU or greater is more preferable, and a layer in which the permeation rate of carbon dioxide is 2000 GPU or greater is still more preferable. However, the permeability of the porous support layer used in the present invention is not limited to the description above and can be appropriately selected depending on the target to be separated and the purpose thereof.

Examples of the material of the porous support layer include known polymers of the related art, for example, a polyolefin-based resin such as polyethylene or polypropylene; a fluorine-containing resin such as polytetrafluoroethylene, polyvinyl fluoride, or polyvinylidene fluoride; and various resins such as polystyrene, cellulose acetate, polyurethane, polyacrylonitrile, polyphenylene oxide, polysulfone, polyether sulfone, polyimide, and polyaramid. As the shape of the porous support layer, any shape from among a flat plate shape, a spiral shape, a tabular shape, and a hollow fiber shape can be employed.

In the lower portion of the porous support layer used in the present invention, it is preferable that a support is formed to impart the mechanical strength. Examples of such a support include woven fabric, non-woven fabric, and a net. Among these, from the viewpoints of membrane forming properties and the cost, non-woven fabric is suitably used. As the non-woven fabric, fibers formed of polyester, polypropylene, polyacrylonitrile, polyethylene, and polyamide may be used alone or in combination of plural kinds thereof. The non-woven fabric can be produced by papermaking main fibers and binder fibers which are uniformly dispersed in water using a circular net or a long net and then drying the fibers with a dryer. Moreover, for the purpose of removing a nap or improving mechanical properties, it is preferable that thermal pressing processing is performed on the non-woven fabric by interposing the non-woven fabric between two rolls.

<Separation Layer>

The separation layer included in the composite membrane according to the embodiment of the present invention has two kinds of polymers having different characteristics, in other words, the following polymer a1 and the following polymer b1.

(Characteristics of Polymer a1)

The polymer a1 is a polymer in which the ratio of the permeation rate of carbon dioxide to the permeation rate of methane (hereinafter, also simply referred to as the “permeation rate ratio of the polymer a1”) is 15 or greater and the permeation rate of the carbon dioxide in the polymer a1 (hereinafter, also simply referred to as the “permeation rate of the polymer a1”) is smaller than the permeation rate in the polymer b1 constituting the separation layer by being combined with the polymer a1.

The solubility parameter (SP value) of the polymer a1 is 21 or greater.

(Characteristics of Polymer b1)

The polymer b1 is a polymer in which the permeation rate of carbon dioxide (hereinafter, also simply referred to as the “permeation rate ratio of the polymer b1”) is 200 GPU or greater and the ratio of the permeation rate of the carbon dioxide to the permeation rate of methane in the polymer b1 (hereinafter, also simply referred to as the “permeation rate ratio of the polymer b1”) is smaller than the permeation rate ratio of the polymer a1 constituting the separation layer by being combined with the polymer b1.

The SP value of the polymer b1 is 16.5 or less.

By allowing the separation layer to contain two kinds of polymers having the specific separation selectivity and the permeability or the SP value described above, a separation membrane which has an excellent permeability while sufficiently exhibiting excellent separation selectivity of the polymer a1 can be realized. The reason for this is not clear, but can be assumed as follows. In other words, by employing polymers having specific SP values separated by a certain value or greater as two kinds of polymers having specific separation performance or specific permeation performance, the polymer a1 and the polymer b1 in the separation layer can enter a predetermined phase separation state. In this manner, it is considered that a uniform thin film without defects can be formed due to the action between the phase of the polymer a1 and the phase of the polymer b1 in contact with the polymer a1 to form a separation layer exhibiting excellent permeability while realizing desired separation selectivity.

The “SP value” in the present invention is a value determined by calculation using HSPiP 4^{th} Edition 4.1.07(https://hansen-solubility.com/downloads.php). At the time of calculation of the polymer structure, both terminals of the repeating unit structure are calculated as “*”. In a case of a cellulose derivative or the like whose substitution position is not uniquely determined, SP values of the structures substituted with each substituent by 100% are respectively calculated, and the total value obtained by multiplying respective substituent ratios is used. An example is shown below.

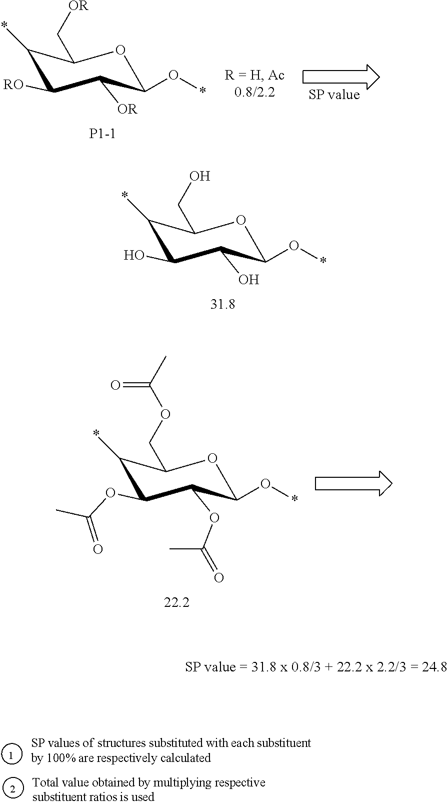

In the present invention, the permeation ratios of methane and carbon dioxide are determined using the method described in examples below.

The permeation rate ratio of the polymer a1 is preferably 18 or greater, more preferably 20 or greater, still more preferably 22 or greater, and even still more preferably 25 or greater. The permeation rate ratio of the polymer a1 is practically 100 or less and typically 80 or less.

Further, the permeation rate of the polymer a1 is typically 200 GPU or less.

Further, the SP value of the polymer a1 is preferably 23.5 or greater and more preferably 24.0 or greater. The SP value of the polymer a1 is typically 30 or less.

The type of the polymer of such a polymer a1 is not particularly limited, and a wide range of polymers satisfying the requirements defined in the present invention can be used. Typical examples thereof include a cellulose compound, a polyimide compound, a polyamide compound, a polyacrylamide compound, a polymethacrylamide compound, and a polysulfone compound. Among these, a cellulose compound is suitable. The polymer a1 satisfying the permeation rate, the SP value, and the like defined in the present invention can be relatively easily obtained by adjusting the forms of the substituents of these polymers.

The permeation rate of the polymer b1 is preferably 300 GPU or greater, more preferably 350 GPU or greater, and still more preferably 400 GPU or greater. The permeation rate ratio of the polymer b1 is practically 1200 or less and typically 800 or less.

Further, the permeation rate of the polymer b1 is typically 5 GPU or less.

Further, the SP value of the polymer b1 is preferably 15.5 or greater and more preferably 15 or greater. The SP value of the polymer b1 is typically 14 or less.

The type of the polymer of such a polymer b1 is not particularly limited, and a wide range of polymers satisfying the requirements defined in the present invention can be used, and it is preferable to use acrylic acid ester or methacrylic acid ester whose separation performance or SP value is relatively easily adjusted. The form of each substituent in an alcohol moiety of the acrylic acid ester and the methacrylic acid ester can be appropriately adjusted depending on the purpose thereof, and thus the polymer b1 satisfying the permeation rate, the SP value, and the like defined in the present invention can be relatively easily obtained. In order to obtain the polymer b1 obtained by decreasing the SP value to a desired level, it is preferable to use acrylic acid ester and methacrylic acid ester obtained by introducing fluorine atoms to the alcohol moiety.

It is preferable that the content of the polymer a1 is smaller than the content of the polymer b1, in the separation layer of the composite membrane according to the embodiment of the present invention. The separation selectivity of the polymer a1 can be sufficiently exhibited even in a case where the amount of the polymer a1 in the separation layer is reduced by a certain value. In addition, since the permeability of the polymer a1 is lower than that in the polymer b1, the permeability of the separation layer is restricted by the polymer a1 in a case where the amount of the polymer a1 is small. In the separation layer of the composite membrane according to the embodiment of the present invention, the proportion of the content of the polymer a1 in the total content of the polymer a1 and the polymer b1 is preferably 40% by mass or less and more preferably 20% by mass or less. Further, in the separation layer of the composite membrane according to the embodiment of the present invention, the proportion of the content of the polymer a1 in the total content of the polymer a1 and the polymer b1 is typically 5% by mass or greater and preferably 8% by mass or greater from the viewpoint of realizing sufficient separation selectivity.

It is preferable that the separation layer constituting the composite membrane according to the embodiment of the present invention exhibits desired mechanical strength or separation selectivity and is formed into a membrane as thin as possible under a condition in which desired excellent permeability is imparted. The thickness of the separation layer constituting the composite membrane according to the embodiment of the present invention is preferably 2 to 400 nm and more preferably in a range of 5 to 200 nm.

[Production of Separation Composite Membrane]

The composite membrane according to the embodiment of the present invention can be obtained by forming the separation layer on the porous support layer. It is preferable that the composite membrane is formed by coating the porous support layer with the coating solution (the composition for forming a separation membrane) obtained by dissolving the polymer a1 and the polymer b1 in a solvent to form a coated film and drying this coated film. The total content of the polymer a1 and the polymer b1 in the coating solution is preferably in a range of 0.1% to 30% by mass and more preferably in a range of 0.5% to 20% by mass.

In the present invention, the SP value of the polymer a1 contributing to the separation selectivity is sufficiently higher than the SP value of the polymer b1. Accordingly, the polymer a1 and the polymer b1 are layer-separated in the coated film formed by coating the porous support layer with the coating solution to form a separation layer such that the layer b2 of the polymer b1 having a small SP value covers the layer a2 of the polymer a1 as illustrated in FIG. 1. In this manner, the layer a2 of the polymer a1 can be formed into an ultrathin layer, and a separation layer exhibiting sufficient separation selectivity while effectively suppressing a decrease in the permeation rate can be formed.

The coating method of coating the porous support layer with the coating solution is not particularly limited, and a typical method can be employed. Examples thereof include known coating methods such as spin coating, extrusion die coating, blade coating, bar coating, screen printing, stencil printing, roll coating, curtain coating, spray coating, dip coating, an ink jet printing method, and an immersion method. Among these, a spin coating method or a screen printing method is preferable.

Such a solvent as a medium of the coating solution is not particularly limited, and examples thereof include a hydrocarbon such as n-hexane or n-heptane; an ester such as methyl acetate, ethyl acetate, or butyl acetate; an alcohol such as methanol, ethanol, n-propanol, isopropanol, n-butanol, isobutanol, tert-butanol, ethylene glycol, diethylene glycol, triethylene glycol, glycerin, or propylene glycol; an aliphatic ketone such as acetone, methyl ethyl ketone, methyl isobutyl ketone, diacetone alcohol, cyclopentanone, or cyclohexanone; an ether such as ethylene glycol monomethyl ether, ethylene glycol monoethyl ether, propylene glycol methyl ether, dipropylene glycol methyl ether, tripropylene glycol methyl ether, ethylene glycol phenyl ether, propylene glycol phenyl ether, diethylene glycol monomethyl ether, diethylene glycol monoethyl ether, diethylene glycol monobutyl ether, triethylene glycol monomethyl ether, triethylene glycol monoethyl ether, dibutyl butyl ether, tetrahydrofuran, methyl cyclopentyl ether, dioxane, or dioxolane; and N-methylpyrrolidone, 2-pyrrolidone, dimethylformamide, dimethylimidazolidinone, dimethyl sulfoxide, and dimethyl acetamide. These organic solvents are appropriately selected within the range that does not adversely affect the support through erosion or the like, and an ester (preferably butyl acetate), an alcohol (preferably methanol, ethanol, isopropanol, isobutanol, or ethylene glycol), an aliphatic ketone (preferably methyl ethyl ketone, methyl isobutyl ketone, diacetone alcohol, cyclopentanone, or cyclohexanone), and an ether (preferably diethylene glycol monomethyl ether, methyl cyclopentyl ether, or dioxolane) are preferable and an aliphatic ketone, an alcohol, and/or an ether are more preferable.

Various polymer compounds other than the polymer a1 and the polymer b1 can be added to the coating solution in order to adjust the membrane physical properties. As the polymer compounds, an acrylic polymer, a polyurethane resin, a polyamide resin, a polyester resin, an epoxy resin, a phenol resin, a polycarbonate resin, a polyvinyl butyral resin, a polyvinyl formal resin, shellac, a vinyl-based resin, an acrylic resin, a rubber-based resin, waxes, and other natural resins can be used. Further, these may be used in combination of two or more kinds thereof.

Further, a non-ionic surfactant, a cationic surfactant, an organic fluoro compound, and the like can be added to the coating solution in order to adjust the liquid physical properties of the coating solution.

Specific examples of the surfactant include anionic surfactants such as alkyl benzene sulfonate, alkyl naphthalene sulfonate, higher fatty acid salts, sulfonate of higher fatty acid ester, sulfuric ester salts of higher alcohol ether, sulfonate of higher alcohol ether, alkyl carboxylate of higher alkyl sulfonamide, and alkyl phosphate; non-ionic surfactants such as polyoxyethylene alkyl ether, polyoxyethylene alkyl phenyl ether, polyoxyethylene fatty acid ester, sorbitan fatty acid ester, an ethylene oxide adduct of acetylene glycol, an ethylene oxide adduct of glycerin, and polyoxyethylene sorbitan fatty acid ester; and amphoteric surfactants such as alkyl betaine and amide betaine; a silicon-based surfactant; and a fluorine-based surfactant, and the surfactant can be suitably selected from known surfactants and derivatives thereof in the related art.

Further, the coating solution may contain a polymer dispersant, and specific examples of the polymer dispersant include polyvinyl pyrrolidone, polyvinyl alcohol, polyvinyl methyl ether, polyethylene oxide, polyethylene glycol, polypropylene glycol, and polyacrylamide. Among these, polyvinyl pyrrolidone is preferably used.

The conditions for forming the separation layer are not particularly limited. The coating temperature thereof is preferably in a range of −30° C. to 100° C., more preferably in a range of −10° C. to 80° C., and particularly preferably in a range of 5° C. to 50° C.

In the present invention, gas such as air or oxygen may be allowed to coexist at the time of formation of the separation layer, and it is desirable that the separation layer is formed in an inert gas atmosphere.

In the composite membrane according to the embodiment of the present invention, the total content of the polymer a1 and the polymer b1 in the separation layer is not particularly limited as long as desired separation performance is obtained. From the viewpoint of further improving separation performance, the total content of the polymer a1 and the polymer b1 in the separation layer is preferably 20% by mass or greater, more preferably 40% by mass or greater, still more preferably 60% by mass or greater, even still more preferably 70% by mass or greater, even still more preferably 80% by mass, and particularly preferably 90% by mass or greater. Further, the total content of the polymer a1 and the polymer b1 in the separation layer may be 100% by mass and is typically 99% by mass or less.

(Another Layer Between Porous Support Layer and Separation Layer)

In the composite membrane of the present invention, another layer may be present between the porous support layer and the separation layer. Preferred examples of another layer include a siloxane compound layer. By providing a siloxane compound layer, unevenness of the outermost surface of the support layer can be made to be smooth and the thickness of the gas separation layer is easily reduced. Examples of a siloxane compound that forms the siloxane compound layer include a compound in which the main chain is formed of polysiloxane and a compound having a siloxane structure and a non-siloxane structure in the main chain.

In the present specification, the “siloxane compound” indicates an organopolysiloxane compound unless otherwise specified.

—Siloxane Compound Whose Main Chain is Formed of Polysiloxane —

As the siloxane compound which can be used for the siloxane compound layer and whose main chain is formed of polysiloxane, one or two or more kinds of polyorganopolysiloxanes represented by Formula (1) or (2) may be exemplified. Further, these polyorganopolysiloxanes may form a crosslinking reactant. As the crosslinking reactant, a compound in the form of the compound represented by Formula (1) being crosslinked by a polysiloxane compound having groups linked to each other by reacting with a reactive group X^{S} of Formula (1) at both terminals is exemplified.

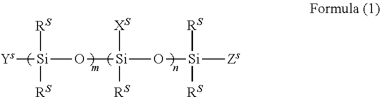

In Formula (1), R^{S} represents a non-reactive group. Specifically, it is preferable that R^{S} represents an alkyl group (an alkyl group having preferably 1 to 18 carbon atoms and more preferably 1 to 12 carbon atoms) or an aryl group (an aryl group having preferably 6 to 15 carbon atoms and more preferably 6 to 12 carbon atoms; and more preferably phenyl).

X^{S} represents a reactive group, and it is preferable that X^{S} represents a group selected from a hydrogen atom, a halogen atom, a vinyl group, a hydroxyl group, and a substituted alkyl group (an alkyl group having preferably 1 to 18 carbon atoms and more preferably 1 to 12 carbon atoms).

Y^{S} and Z^{S} are the same as R^{S} or X^{S} described above.

m represents a number of 1 or greater and preferably 1 to 100,000.

n represents a number of 0 or greater and preferably 0 to 100,000.

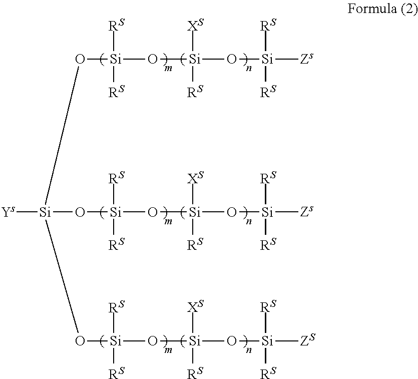

In Formula (2), X^{S}, Y^{S}, Z^{S}, R^{S}, m, and n each have the same definition as that for X^{S}, Y^{S}, Z^{S}, R^{S}, m, and n in Formula (1).

In Formulae (1) and (2), in a case where the non-reactive group R^{S} represents an alkyl group, examples of the alkyl group include methyl, ethyl, hexyl, octyl, decyl, and octadecyl. Further, in a case where the non-reactive group R represents a fluoroalkyl group, examples of the fluoroalkyl group include —CH₂CH₂CF₃, and —CH₂CH₂C₆F₁₃

In Formulae (1) and (2), in a case where the reactive group X^{S} represents a substituted alkyl group, examples of the alkyl group include a hydroxyalkyl group having 1 to 18 carbon atoms, an aminoalkyl group having 1 to 18 carbon atoms, a carboxyalkyl group having 1 to 18 carbon atoms, a cycloalkyl group having 1 to 18 carbon atoms, a glycidoxyalkyl group having 1 to 18 carbon atoms, a glycidyl group, an epoxycyclohexylalkyl group having 7 to 16 carbon atoms, a (1-oxacyclobutane-3-yl)alkyl group having 4 to 18 carbon atoms, a methacryloxyalkyl group, and a mercaptoalkyl group.

The number of carbon atoms of the alkyl group constituting the hydroxyalkyl group is preferably an integer of 1 to 10, and examples of the hydroxyalkyl group include —CH₂CH₂CH₂OH.

The number of carbon atoms of the alkyl group constituting the aminoalkyl group is preferably an integer of 1 to 10, and examples of the aminoalkyl group include —CH₂CH₂CH₂NH₂.

The number of carbon atoms of the alkyl group constituting the carboxyalkyl group is preferably an integer of 1 to 10, and examples of the carboxyalkyl group include —CH₂CH₂CH₂COOH.

The number of carbon atoms of the alkyl group constituting the chloroalkyl group is preferably an integer of 1 to 10, and preferred examples of the chloroalkyl group include —CH₂Cl.

The number of carbon atoms of the alkyl group constituting the glycidoxyalkyl group is preferably an integer of 1 to 10, and preferred examples of the glycidoxyalkyl group include 3-glycidyloxypropyl.

The number of carbon atoms of the epoxycyclohexylalkyl group having 7 to 16 carbon atoms is preferably an integer of 8 to 12.

The number of carbon atoms of the (1-oxacyclobutane-3-yl)alkyl group having 4 to 18 carbon atoms is preferably an integer of 4 to 10.

The number of carbon atoms of the alkyl group constituting the methacryloxyalkyl group is preferably an integer of 1 to 10, and examples of the methacryloxyalkyl group include —CH₂CH₂CH₂—OOC—C(CH₃)═CH₂.

The number of carbon atoms of the alkyl group constituting the mercaptoalkyl group is preferably an integer of 1 to 10, and examples of the mercaptoalkyl group include —CH₂CH₂CH₂SH.

It is preferable that m and n represent a number in which the molecular weight of the compound is in a range of 5,000 to 1000,000.

In Formulae (1) and (2), distribution of a reactive group-containing siloxane unit (in the formulae, a constitutional unit whose number is represented by n) and a siloxane unit (in the formulae, a constitutional unit whose number is represented by m) which does not have a reactive group is not particularly limited. That is, in Formulae (1) and (2), the (Si(R^{S})(R^{S})—O) unit and the (Si(R^{S})(X^{S})—O) unit may be randomly distributed.

—Compound Having Siloxane Structure and Non-Siloxane Structure in Main Chain —

Examples of the compound which can be used for the siloxane compound layer and has a siloxane structure and a non-siloxane structure in the main chain include compounds represented by Formulae (3) to (7).

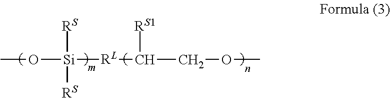

In Formula (3), R^{S}, m, and n each have the same definition as that for R^{S}, m, and n in Formula (1). R^{L} represents —O— or —CH₂— and R^{S1} represents a hydrogen atom or methyl. It is preferable that both terminals of Formula (3) are formed of an amino group, a hydroxyl group, a carboxy group, a trimethylsilyl group, an epoxy group, a vinyl group, a hydrogen atom, or a substituted alkyl group.

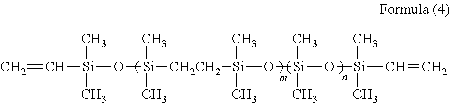

In Formula (4), m and n each have the same definition as that for m and n in Formula (1).

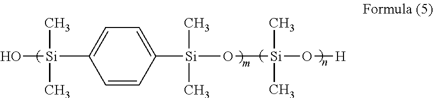

In Formula (5), m and n each have the same definition as that for m and n in Formula (1).

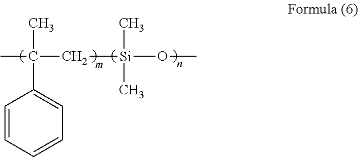

In Formula (6), m and n each have the same definition as that for m and n in Formula (1). It is preferable that both terminals of Formula (6) are bonded to an amino group, a hydroxyl group, a carboxy group, a trimethylsilyl group, an epoxy group, a vinyl group, a hydrogen atom, or a substituted alkyl group.

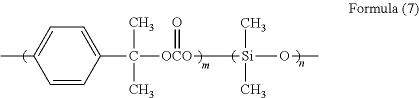

In Formula (7), m and n each have the same definition as that for m and n in Formula (1). It is preferable that both terminals of Formula (7) are bonded to an amino group, a hydroxyl group, a carboxy group, a trimethylsilyl group, epoxy, a vinyl group, a hydrogen atom, or a substituted alkyl group.

In Formulae (3) to (7), distribution of a siloxane structural unit and a non-siloxane structural unit may be randomly distributed.

It is preferable that the compound having a siloxane structure and a non-siloxane structure in the main chain contains 50% by mole or greater of the siloxane structural unit and more preferable that the compound contains 70% by mole or greater of the siloxane structural unit with respect to the total molar amount of all repeating structural units.

From the viewpoint of achieving the balance between durability and reduction in membrane thickness, the weight-average molecular weight of the siloxane compound used for the siloxane compound layer is preferably in a range of 5,000 to 1,000,000. The method of measuring the weight-average molecular weight is as described above.

Further, preferred examples of the siloxane compound constituting the siloxane compound layer are as follows.

Preferred examples thereof include one or two or more selected from organopolysiloxane, polydimethylsiloxane, polymethylphenylsiloxane, polydiphenylsiloxane, a polysulfone/polyhydroxystyrene/polydimethylsiloxane copolymer, a dimethylsiloxane/methylvinylsiloxane copolymer, a dimethylsiloxane/diphenylsiloxane-methylvinylsiloxane copolymer, a methyl-3,3,3-trifluoropropylsiloxane/methylvinylsiloxane copolymer, a dimethylsiloxane/methylphenylsiloxane/methylvinylsiloxane copolymer, a vinyl terminated diphenylsiloxane/dimethylsiloxane copolymer, vinyl terminated polydimethylsiloxane, H terminated polydimethylsiloxane, and a dimethylsiloxane/methylhydroxysiloxane copolymer. Further, these compounds also include the forms of forming crosslinking reactants.

In the composite membrane of the present invention, from the viewpoints of smoothness and gas permeability, the thickness of the siloxane compound layer is preferably in a range of 0.01 to 5 μm and more preferably in a range of 0.05 to 1 μm.

Further, the gas permeability of the siloxane compound layer at 40° C. and 4 MPa is preferably 100 GPU or greater, more preferably 300 GPU or greater, and still more preferably 1000 GPU or greater in terms of the permeation rate of carbon dioxide.

[Use and Characteristics of Gas Separation Membrane]

The composite membrane according to the embodiment of the present invention can be widely used for separation of various fluids. For example, the composite membrane can be applied to ultrafiltration membranes, nanofiltration membranes, forward osmosis membranes, reverse osmosis membranes, gas separation membranes, and the like.

Among there, the composite membrane is suitably used as a gas separation membrane that separates and recovers a specific gas from a mixed gas containing two or more kinds of gas components. For example, a gas separation membrane which is capable of efficiently separating specific gas from a gas mixture containing gas, for example, saturated hydrocarbon such as hydrogen, helium, carbon monoxide, carbon dioxide, hydrogen sulfide, oxygen, nitrogen, ammonia, a sulfur oxide, a nitrogen oxide, methane, or ethane; unsaturated hydrocarbon such as propylene; or a perfluoro compound such as tetrafluoroethane can be obtained. Particularly, it is preferable that a gas separation membrane selectively separating carbon dioxide from a gas mixture containing carbon dioxide and hydrocarbon (preferably methane) is obtained.

The pressure at the time of gas separation is preferably in a range of 0.5 MPa to 10 MPa, more preferably in a range of 1 MPa to 10 MPa, and still more preferably in a range of 2 MPa to 7 MPa. Further, the temperature for separating gas is preferably in a range of −30° C. to 90° C. and more preferably in a range of 15° C. to 70° C. In the mixed gas containing carbon dioxide and methane gas, the mixing ratio of carbon dioxide to methane gas is not particularly limited. The mixing ratio thereof (carbon dioxide:methane gas) is preferably in a range of 1:99 to 99:1 (volume ratio) and more preferably in a range of 5:95 to 90:10.

[Separation Membrane Module and Gas Separator]

A separation membrane module can be prepared using the composite membrane according to the embodiment of the present invention. Examples of the module include a spiral type module, a hollow fiber type module, a pleated module, a tubular module, and a plate and frame type module.

Moreover, it is possible to obtain a separator having means for performing separation and recovery of a fluid or performing separation and purification of a fluid by using the composite membrane according to the embodiment of the present invention or the separation membrane module. The composite membrane according to the embodiment of the present invention may be applied to a gas separation and recovery device which is used together with an absorption liquid described in JP2007-297605A according to a membrane/absorption hybrid method.

### EXAMPLES

Hereinafter, the present invention will be described in detail with reference to examples, but the present invention is not limited to these examples.

### Synthesis Example

Polymers formed of repeating units shown below were prepared. In the present specification, Ac represents acetyl and Et represents ethyl. The symbol “*” represents a linking site for being incorporated in the polymer main chain. Further, “0.8/2.2” in P1-1 and “0.6/2.4” in P1-2 indicate [R as H]/[R as Ac] (ratio of numbers), and “0.4/2.6” in P2-7 indicates [R as H]/[R as Et] (ratio of numbers)

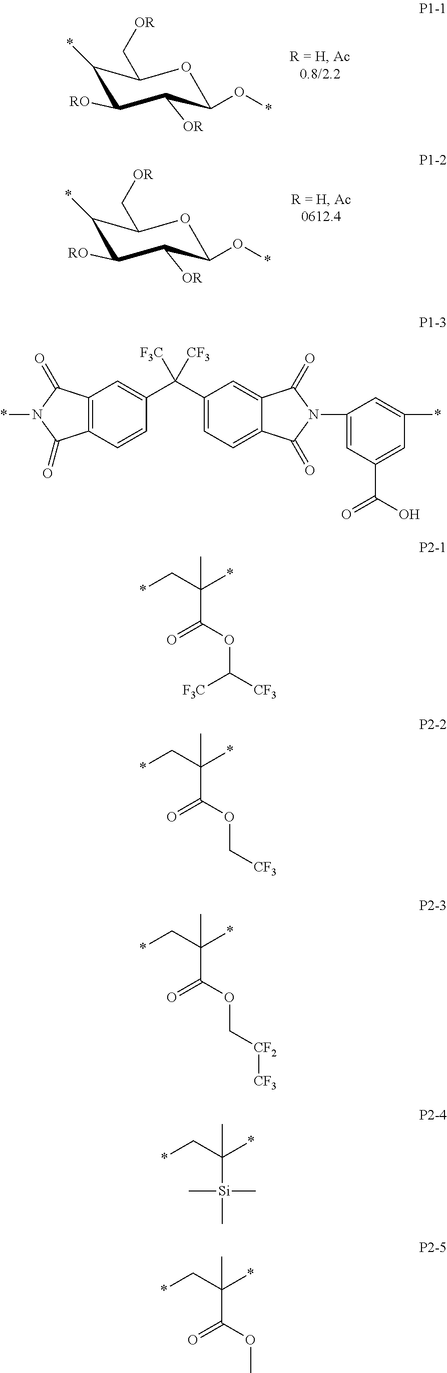

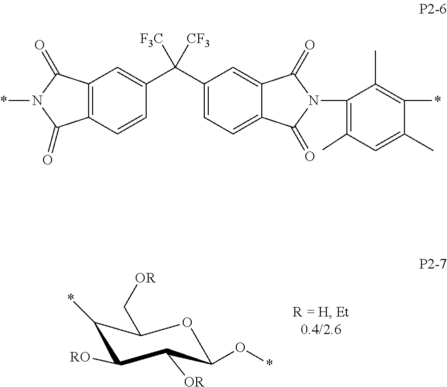

<P1-1>

FL-70, manufactured by Daicel Corporation

<P1-2>

L-70, manufactured by Daicel Corporation

<Synthesis of P1-3>

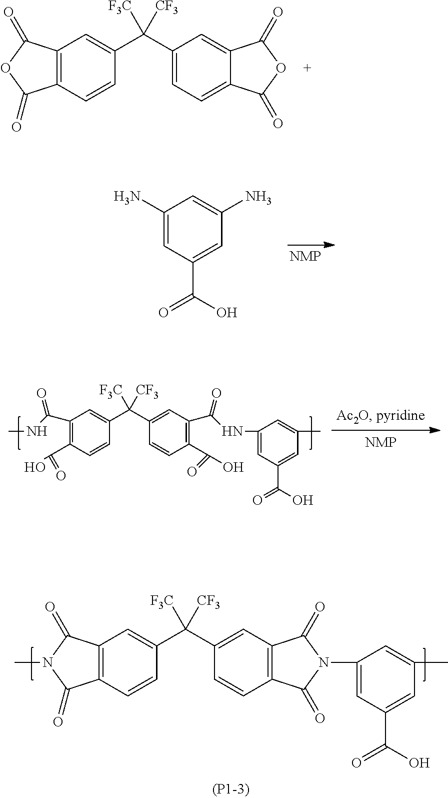

21.3 g (0.14 mol) of 3,5-diaminobenzoic acid (manufactured by Tokyo Chemical Industry Co., Ltd.) and 423.9 g of N-methylpyrrolidone (NMP, manufactured by Wako Pure Chemical Industries, Ltd.) were added to a 2 L three-neck flask and dissolved, and the solution was stirred in a nitrogen flow, 60.3 g (0.14 mol) of a 4,4′-(hexafluoroisopropylidene) diphthalic anhydride (manufactured by Tokyo Chemical Industry Co., Ltd.) was added to the solution, and the resulting solution was stirred at 40° C. for 3.5 hours. Thereafter, 3.2 g (0.04 mol) (manufactured by Wako Pure Chemical Industries, Ltd.) and 45.8 g (0.45 mol) of acetic anhydride (manufactured by Wako Pure Chemical Industries, Ltd.) were added to the solution, and the resulting solution was further stirred at 80° C. for 3 hours. Thereafter, the solution was cooled to 40° C. or lower, and 500.0 mL of acetone was added to the reaction solution so that the solution was diluted. The diluent was transferred to a 3 L three-neck flask and stirred, and 2.0 L of methanol was added dropwise thereto. The obtained polymer crystals were suctioned, filtered, and dried by blowing air thereto at 40° C., thereby obtaining 69.5 g of P1-3. The weight-average molecular weight of P1-3 was 149300.

<Synthesis of P2-1>

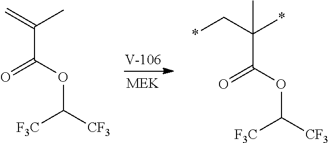 [SMILES: C=C(C)C(=O)OC(C(F)(F)F)C(F)(F)F ; *CC(*)(C)C(=O)OC(C(F)(F)F)C(F)(F)F]

23.6 g of hexafluoroisopropyl methacrylate (manufactured by Wako Pure Chemical Industries, Ltd.), 0.12 g of dimethyl 2,2′-azobis(isobutyrate) (V-601, manufactured by Wako Pure Chemical Industries, Ltd.), and 43.8 g of methyl ethyl ketone (MEK, manufactured by Wako Pure Chemical Industries, Ltd.) were added to a 200 mL three-neck flask and dissolved, and the solution was stirred at 80° C. for 6 hours in a nitrogen flow. In the middle of the process, 0.02 g of V-601 was added thereto after 2 hours and 4 hours. Thereafter, the solution was cooled to 40° C. or lower, and 100 ml of methanol was added to the reaction solution so that the solution was diluted. The diluent was added dropwise to a mixed solution of 540 ml of methanol and 60 ml of water. The obtained polymer crystals were suctioned, filtered, and dried by blowing air thereto at 40° C., thereby obtaining 12.8 g of P2-1. The weight-average molecular weight of P2-1 was 20100.

<Synthesis of P2-2 and P2-3>

P2-2 and P2-3 were obtained in the same manner as in the synthesis of P2-1 except that the hexafluoroisopropyl methacrylate in the synthesis of P2-1 was changed to monomers corresponding to P2-2 and P2-3. The weight-average molecular weight of P2-2 was 22500, and the weight-average molecular weight of P2-3 was 21200.

<P2-4>

POLY(TRIMETHYLSILYL)PROPYNE (manufactured by Azmax. Co., Ltd.)

<P2-5>

Poly(methyl methacrylate) (manufactured by Sigma-Aldrich Co., LLC), weight-average molecular weight of 120000

<Synthesis of P2-6>

P2-6 was obtained in the same manner as in the synthesis of P1-3 except that the 3,5-diaminobenzoic acid in the synthesis of P1-3 was changed to a diamine corresponding to P2-6. The weight-average molecular weight of P2-6 was 133100.

<P2-7>

Methyl cellulose (manufactured by Wako Pure Chemical Industries, Ltd.)

### [Production Example 1] Preparation of Composite Membrane

<Preparation of PAN Porous Membrane Provided with Smooth Layer>

(Preparation of Radiation-Curable Polymer Containing Dialkylsiloxane Group)

39 g of UV9300 (manufactured by Momentive Performance Materials Inc.), 10 g of X-22-162C (manufactured by Shin-Etsu Chemical Co, Ltd.), and 0.007 g of DBU (1,8-diazabicyclo[5.4.0]undeca-7-ene) were added to a 150 mL three-neck flask and dissolved in 50 g of n-heptane. The state of the solution was maintained at 95° C. for 168 hours, thereby obtaining a radiation-curable polymer solution (viscosity at 25° C. was 22.8 mPa·s) containing a poly(siloxane) group.

(Preparation of Polymerizable Radiation-Curable Composition)

5 g of the obtained radiation-curable polymer solution was cooled to 20° C. and diluted with 95 g of n-heptane. 0.5 g of UV9380C (manufactured by Momentive Performance Materials Inc.) serving as a photopolymerization initiator and 0.1 g of ORGATIX TA-10 (manufactured by Matsumoto Fine Chemical Co., Ltd.) were added to the obtained solution, thereby preparing a polymerizable radiation-curable composition.

(Coating of Porous Support Layer with Polymerizable Radiation-Curable Composition and Formation of Smooth Layer)

The polyacrylonitrile (PAN) porous membrane (the PAN porous membrane was present on non-woven fabric, the membrane thickness including the thickness of the non-woven fabric was approximately 180 μm, and the permeation rate of carbon dioxide in this porous membrane in a state of including non-woven fabric was 25000 GPU under the same conditions as the conditions for evaluation of the permeation rate described below) was used as a support layer and spin-coated with the polymerizable radiation-curable composition, subjected to a UV treatment (Light Hammer 10, D-valve, manufactured by Fusion UV System, Inc.) under UV treatment conditions of a UV intensity of 24 kW/m for a treatment time of 10 seconds, and then dried. In this manner, a smooth layer containing a dialkylsiloxane group and having a thickness of 1 μm was formed on the porous support layer. In the laminate in which the smooth layer was provided on the porous support layer (including non-woven fabric), the permeation rate of the carbon dioxide at the time of supplying a mixed gas from the side of the smooth layer was 1500 GPU under the same measurement conditions as the conditions for the evaluation of the permeation rate described below.

<Preparation of Composite Membrane>

The composite membrane illustrated in FIG. 1 was prepared (the smooth layer and the non-woven fabric are not illustrated in FIG. 1).

0.032 g of P1-1, 0.048 g of P2-1, 3.960 g of methyl ethyl ketone (MEK), and 3.960 g of 1,3-dioxolane were mixed in a 30 ml brown vial bottle and then stirred for 30 minutes, the smooth layer of the PAN porous membrane on which the smooth layer was formed was spin-coated with the mixed solution to form a separation layer, and the solution was dried, thereby obtaining a composite membrane (Example 1). The thickness of the separation layer was 100 nm.

### [Production Examples 2 to 6 and Comparative Production Examples 1 to 3] Preparation of Composite Membrane

The composite membranes of Production Examples 2 to 6 and Comparative Production Examples 1 to 3 were prepared in the same manner as in Production Example 1 except that the combination of the polymers and the solvents in the <preparation of composite membrane> in Production Example 1 were changed to those listed in the following table.

[Method of Evaluating Polymer Characteristics]

<Evaluation of Permeation Rates of Methane and Carbon Dioxide>

The permeation rate of methane and carbon dioxide of each polymer were measured in the following manner.

<Preparation of Polymer Solution and Evaluation Membrane>

Each polymer synthesized in the above-described manner was dissolved alone in various solvents listed in the following table in consideration of the solubility of each polymer (the polymer cannot sufficiently be dissolved at a concentration of 1% by mass) to prepare a coating solution having a polymer concentration of 1% by mass.

TABLE 1

| | |
|---|---|
| P1-1 | 1,3-Dioxolane |
| P1-2 | 1,3-Dioxolane |
| P1-3 | MEK |
| P2-1 | MEK |
| P2-2 | MEK |
| P2-3 | MEK |
| P2-4 | Tetrahydrofuran |
| P2-5 | MEK |
| P2-6 | MEK |
| P2-7 | 1,3-Dioxolane |

The PAN porous membrane on which the smooth layer was formed, which was used for preparation of the composite membrane, was used as a porous support layer, the smooth layer was spin-coated with a polymer solution to form a polymer layer, and the polymer solution was dried at 90° C., thereby obtaining an evaluation membrane having a membrane formed of the polymer (one kind) as a target for measuring the permeation rate, on the porous support layer. The thickness of the polymer layer was 100 nm.

In other words, in the present invention, the “permeation rate” of the polymer with respect to a fluid component was measured using a composite membrane obtained by providing a polymer layer with a thickness of 100 nm on the laminate in which the smooth layer was provided on the PAN porous membrane (including the non-woven support).

(Evaluation of Permeation Rate Between Methane and Carbon Dioxide)

Each permeation test sample was prepared by cutting the whole porous support layer of the evaluation membrane in a circular shape with a diameter of 5 cm. A mixed gas in which the volume ratio of carbon dioxide (CO₂) to methane (CH₄) was 10:90 was prepared by adjusting the total pressure on the gas supply side to 5 MPa (partial pressure of CO₂: 0.3 MPa), the flow rate thereof to 500 mL/min, the temperature thereof to 40° C. using a gas permeability measuring device (manufactured by GTR TEC Corporation), and the mixed gas was supplied from the separation layer side. The gas that had permeated was analyzed using gas chromatography, and the permeation rate was calculated based on the gas permeability (Permeance). The unit of the permeation rate was expressed as the unit of GPU (gas permeation unit) [1 GPU=1×10⁻⁶ cm³ (STP)/cm²·sec·cmHg]. The ratio of the permeation rate of carbon dioxide to the permeation rate of methane was calculated as the ratio (R_{CO2}/R_{CH4}) of the permeation rate R_{CO2} of carbon dioxide to the permeation rate R_{CH4} of methane of the evaluation membrane. Further, STP stands for standard temperature and pressure, and 1×10⁻⁶ cm³ (STP) is the volume of a gas at 0° C. and 1 atm.

<Sp Value>

The SP value of each polymer was determined in the above-described manner.

### [Test Example] Test for Separation Performance of Composite Membrane

The separation performance of each composite membrane produced in each production example and each comparative example was evaluated in the same manner as in the evaluation of the permeation rate described above. It can be determined that sufficient separation performance is exhibited in a case where the permeation rate ratio is 10 or greater and the permeation rate is 80 or greater. The results are listed in the following table.

TABLE 2

| | Polymer a1 | | | | Polymer b1 | | | |
|---|---|---|---|---|---|---|---|---|
| | | | Permeation rate | Permeation | | | Permeation rate | Permeation |
| | | | ratio | rate | | | ratio | rate |
| | Polymer | SP value | (R_{CO2}/R_{CH4}) | (R_{CO2}) | Polymer | SP value | (R_{CO2}/R_{CH4}) | (R_{CO2}) |
| Example 1 | P1-1 | 24.8 | 26.8 | 18 | P2-1 | 14.6 | 5 or less | 512 |
| Example 2 | P1-1 | 24.8 | 26.8 | 18 | P2-1 | 14.6 | 5 or less | 512 |
| Example 3 | P1-2 | 24.1 | 19.3 | 55 | P2-1 | 14.6 | 5 or less | 512 |
| Example 4 | P1-3 | 21.4 | 36.1 | 38 | P2-1 | 14.6 | 5 or less | 512 |
| Example 5 | P1-1 | 24.8 | 26.8 | 18 | P2-2 | 16.1 | 5 or less | 204 |
| Example 6 | P1-1 | 24.8 | 26.8 | 18 | P2-3 | 15.0 | 5 or less | 311 |
| Example 7 | P1-2 | 24.1 | 19.3 | 55 | P2-4 | 14.3 | 5 or less | 330 |
| Comparative | P1-2 | 24.1 | 19.3 | 55 | P2-5 | 17.2 | 5 or less | 9 |
| Example 1 | | | | | | | | |
| Comparative | P1-2 | 24.1 | 19.3 | 55 | P2-6 | 19.7 | 5 or less | 115 |
| Example 2 | | | | | | | | |
| Comparative | P1-2 | 24.1 | 19.3 | 55 | P2-7 | 21.1 | 5 or less | 153 |
| Example 3 | | | | | | | | |

| | | | | Separation performance | |
|---|---|---|---|---|---|
| | | | | Permeation rate | Permeation |
| | Polymer a1/polymer b1 | Solvent | | ratio | rate |
| | (mass ratio) | Type of solvent | Mass ratio | (R_{CO2}/R_{CH4}) | (R_{CO2}) |
| Example 1 | 40/60 | 1,3-Dioxolane/MEK | 50/50 | 16 | 118 |
| Example 2 | 10/90 | 1,3-Dioxolane/MEK | 50/50 | 16 | 160 |
| Example 3 | 10/90 | 1,3-Dioxolane/MEK | 50/50 | 12 | 125 |
| Example 4 | 40/60 | MEK | 100 | 13 | 125 |
| Example 5 | 10/90 | 1,3-Dioxolane/MEK | 50/50 | 14 | 85 |
| Example 6 | 10/90 | 1,3-Dioxolane/MEK | 50/50 | 16 | 101 |
| Example 7 | 20/80 | 1,3-Dioxolane/tetrahydrofuran | 50/50 | 12 | 95 |
| Comparative | 10/90 | 1,3-Dioxolane/MEK | 50/50 | 8 | 13 |
| Example 1 | | | | | |
| Comparative | 10/90 | 1,3-Dioxolane/MEK | 50/50 | 7 | 83 |
| Example 2 | | | | | |
| Comparative | 10/90 | 1,3-Dioxolane | — | 6 | 98 |
| Example 3 | | | | | |

As shown in the table, it was found that the separation permeability (permeation rate ratio) of the obtained composite membrane was degraded in a case where the SP value of the polymer b1 was higher than the value defined in the present invention. The reason for this is considered that a uniform thin film of the polymer a1 was not able to be sufficiently formed due to an increase of the compatibility between the polymer b1 and the polymer a1 (Comparative Examples 1 to 3).

On the contrary, all the composite membranes of Examples 1 to 7 each having the separation layer defined in the present invention effectively exhibited the separation selectivity due to the polymer a1. This result indicates that a uniform thin film of the polymer a1 was formed on the porous support layer in a state the polymer a1 and the polymer b1 constituting the separation layer were phase-separated without being compatible with each other by satisfying the definition of the present invention and the thin film of the polymer a1 was covered by the phase (layer) of the polymer b1 with a low SP value.

Further, as shown in the results of Examples 1 to 7, it was found that the permeability of the composite membrane to be obtained was able to be further increased by employing a polymer having a higher permeability as the polymer b1.

The present invention has been described based on the embodiments, but the present invention is not limited by any detailed description unless otherwise specified. In addition, the present invention should be interpreted broadly without departing from the spirit and the scope of the invention as set forth in the appended claims.

The present application claims priority based on JP2017-037646 filed on Feb. 28, 2017, the contents of which are incorporated herein by reference.

### EXPLANATION OF REFERENCES

2: separation layer
3: porous support layer
10: separation composite membrane

What is claimed is:

1. A separation composite membrane comprising:
a porous support layer; and
a separation layer which is provided on the porous support layer and contains the following polymer a1 and the following polymer b1.
polymer a1: a polymer in which a ratio of a permeation rate of carbon dioxide to a permeation rate of methane is 15 or greater and the permeation rate of the carbon dioxide is smaller than that in the polymer b1 and which has a solubility parameter of 21 or greater
polymer b1: a polymer in which a permeation rate of carbon dioxide is 200 GPU or greater and a ratio of the permeation rate of the carbon dioxide to a permeation rate of methane is smaller than that in the polymer a1 and which has a solubility parameter of 16.5 or less

2. The separation composite membrane according to claim 1,
wherein the separation composite membrane includes the porous support layer, a layer a2 containing the polymer a1, and a layer b2 containing the polymer b1 in this order.

3. The separation composite membrane according to claim 1,
wherein the separation layer is formed using a coating solution obtained by dissolving the polymer a1 and the polymer b1 in a solvent.

4. The separation composite membrane according to any one of claim 1,
wherein a content of the polymer a1 is smaller than a content of the polymer b1 in the separation layer.

5. The separation composite membrane according to any one of claim 1,
wherein a proportion of the content of the polymer a1 in a total content of the polymer a1 and the polymer b1 in the separation layer is 40% by mass or less.

6. The separation composite membrane according to claim 5,
wherein the proportion is 20% by mass or less.

7. The separation composite membrane according to any one of claim 1,
wherein the solubility parameter of the polymer a1 is 23.5 or greater.

8. The separation composite membrane according to any one of claim 1,
wherein the solubility parameter of the polymer a1 is 30 or less.

9. The separation composite membrane according to any one of claim 1,
wherein the solubility parameter of the polymer b1 is 15.5 or less.

10. The separation composite membrane according to any one of claim 1,
wherein the solubility parameter of the polymer b1 is 15 or less.

11. The separation composite membrane according to any one of claim 1,
wherein the solubility parameter of the polymer b1 is 14 or greater.

12. The separation composite membrane according to any one of claim 1,
wherein the polymer a1 is a cellulose compound.

13. The separation composite membrane according to any one of claim 1,
wherein the ratio of the permeation rate of carbon dioxide to the permeation rate of methane in the polymer a1 is 20 or greater.

14. The separation composite membrane according to any one of claim 1,
wherein the permeation rate of carbon dioxide in the polymer b1 is 350 GPU or greater.

15. The separation composite membrane according to any one of claim 1, which is used for gas separation.

16. The separation composite membrane according to claim 15,
wherein a gas as a target for the gas separation is a mixed gas containing carbon dioxide and methane.

17. A separation membrane module comprising:
the separation composite membrane according to any one of claim 1.

18. A separator comprising:
the separation composite membrane according to any one of claim 1.

19. A composition for forming a separation membrane, comprising:
the following polymer a1;
the following polymer b1; and
a solvent.
polymer a1: a polymer in which a ratio of a permeation rate of carbon dioxide to a permeation rate of methane is 15 or greater and the permeation rate of the carbon dioxide is smaller than that in the polymer b1 and which has a solubility parameter of 21 or greater
polymer b1: a polymer in which a permeation rate of carbon dioxide is 200 GPU or greater and a ratio of the permeation rate of the carbon dioxide to a permeation rate of methane is smaller than that in the polymer a1 and which has a solubility parameter of 16.5 or less

20. A method of producing a separation composite membrane, comprising:
coating a porous support layer with the composition for forming a separation membrane according to claim 19 to form a coated film; and
drying the coated film.
